(19) United States
(12) Patent Application Publication
(10) Pub. No.: US 2019/0109312 A1
(43) Pub. Date: Apr. 11, 2019

(54) CONNECTION STRUCTURE FOR POWER STORAGE MODULE AND CONTROL DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroshi SHIMIZU, Mie (JP); Tetsuji TANAKA, Mie (JP); Ryouya OKAMOTO, Mie (JP); Hitoshi TAKEDA, Mie (JP); Tomoki IDOTA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 16/082,779

(22) PCT Filed: Feb. 21, 2017
(86) PCT No.: PCT/JP2017/006282

§ 371 Date: Sep. 6, 2018

(30) Foreign Application Priority Data
Mar. 10, 2016 (JP) 2016-046659

(51) Int. Cl. H01M 2/20; H01M 10/48; H01R 13/629

(52) U.S. Cl. CPC H01M 2/206; H01M 2220/20; H01R 13/62938; H01M 10/482

(57) ABSTRACT

Provided is a connection structure for a power storage module in which a wiring module is mounted on a power storage element group including multiple power storage elements, and for a control device for detecting states of the electrical elements. The power storage module includes detection wires that detect the states of the power storage elements, and that are connected to the control device. A module-side connector that is connected to the detection wires and is integrally provided on the power storage module is fit onto the device-side connector that is integrally provided on the control device.

### TECHNICAL FIELD

The technique disclosed in the present specification relates to a connection structure for a power storage module and a control device.

### BACKGROUND ART

For example, a battery module for a vehicle such as an electric automobile or a hybrid automobile includes multiple single batteries, and has many wires that connect to an ECU unit for detecting and controlling the charging/discharging states of these single batteries. For example, these wires are pulled out from the battery module and bundled, and a battery-side connector provided on the leading end side is fit into a device-side connector provided on the ECU unit side, whereby the wires are connected to the ECU unit.

### CITATION LIST

### Patent Documents

Patent Document 1: JP 2011-91003A

### SUMMARY OF INVENTION

### Technical Problem

Incidentally, the task of fitting together the connectors is performed by holding the battery-side connector in hand, putting the connector on the opening of the device-side connector, and pressing the battery-side connector into the opening, and therefore extra length in the wires that are lead out from the battery module needs to be provided in order to have a length that is sufficient for a routing task. However, after the connectors are fit together, space for routing the extra length portion of the wires that are lead out from the battery module is needed, and there is a problem in that space is taken up.

The technique disclosed in the present specification has been completed based on the foregoing circumstances, and aims to provide a connection structure for a power storage module and a connection device that does not require routing space.

### Solution to the Problem

The technique disclosed in the present specification is a connection structure for a power storage module obtained by attaching a wiring module to a power storage group including a plurality of power storage elements, and for a control device for detecting states of the power storage elements. The power storage module includes detection wires configured to detect the states of the power storage elements, the detection wires being connected to the control device, and a module-side connector that is connected to the detection wires and is provided integrally on the power storage module, and a device-side connector that is provided integrally on the control device, are fit together.

According to the above-described configuration, the module-side connector connected to the detection wires is integrally provided in the power storage module, and therefore it is possible to connect the detection wires to the control device (device-side connector) without pulling the detection wires out of the power storage module. That is, no routing space for the detection wires is needed outside of the power storage module.

The connection structure for the power storage module and the control device may include the following configurations.

It is possible to use a configuration in which the module-side connector includes a module-side housing that contains terminals connected to terminal ends of the detection wires, and a lever having a cam groove is provided on the module-side housing so as to be able to rotate about a support shaft, the device-side connector includes a device-side housing that can fit into the module-side housing, and a cam pin that engages with the cam groove is formed on the device-side housing at a position opposing the lever, and the module-side connector and the device-side connector are fit together and separated through a cam action accompanying engagement of the cam groove and the cam pin through rotation of the lever.

According to the above-described configuration, even if there are many detection wires, the module-side connector and the device-side connector are fit together and separated through a cam action, and therefore the force that is needed during the task can be reduced.

It is possible to use a configuration in which the wiring module includes a resin protector that holds the detection wires, and a fixing portion provided on the module-side connector is fixed to a fixed portion provided on the resin protector.

According to the above-described configuration, the resin protector and module-side connector need only be integrated after being separately manufactured, and therefore the manufacturing cost can be suppressed more compared to the case of manufacturing everything integrally.

It is also possible to use a configuration in which the module-side connector includes a holder, the module-side housing is held such that a tolerance can be absorbed in the holder, and the fixing portion is provided in the holder

According to the above-described configuration, even if a manufacturing allowance and an attachment allowance are generated, it is possible to absorb these allowances.

The fitting-together direction of the battery-side connector and the device-side connector may be set as follows.

If the control device is arranged opposing to the wiring module, the direction in which the module-side connector and the device-side connector are fit together may be set to the alignment direction in which the power storage elements are aligned.

Also, if the control device is arranged opposing the wiring module, the direction in which the module-side connector and the device-side connector are fit together may be set to a direction intersecting the attachment surface of the power storage elements on which the wiring module is attached.

Furthermore, if the control device is arranged aligned in the alignment direction in which the power storage elements are aligned, the direction in which the module-side connector and the device-side connector are fit together may be set to the alignment direction.

With this kind of configuration, the power storage module and the control device can be put together compactly.

### Advantageous Effects of the Invention

According to the technique disclosed in the present specification, it is possible to provide a connection structure for a power storage module and a control device that does not require routing space for detection wires outside of a power storage module.

### BRIEF DESCRIPTION OF DRAWINGS

FIG. 1 is a schematic view showing a connection structure for a battery module and an ECU of Embodiment 1 (before being fit together).

FIG. 2 is a plan view showing the connection structure for the battery module and the ECU (before being fit together).

FIG. 3 is a right-side view showing the connection structure for the battery module and the ECU (before being fit together).

FIG. 4 is a perspective view of a battery-side connector and a device-side connector before being fit together.

FIG. 5 is a plan view of the battery-side connector and the device-side connector before being fit together.

FIG. 6 is a perspective view of the battery-side connector and the device-side connector being fit together.

FIG. 7 is a plan view of the battery-side connector and the device-side connector being fit together.

FIG. 8 is a front view of the battery-side connector and the device-side connector before being fit together.

FIG. 9 is a cross-sectional view taken along line A-A in FIG. 8.

FIG. 10 is a cross-sectional view taken along line B-B in FIG. 8.

FIG. 11 is a perspective view showing the connection structure for the battery module and the ECU (fit-together state).

FIG. 12 is a plan view showing the connection structure for the battery module and the ECU (fit-together state).

FIG. 13 is a right-side view showing the connection structure for the battery module and the ECU (fit-together state).

FIG. 14 is a perspective view of the battery-side connector and the device-side connector in a fit-together state.

FIG. 15 is a plan view of the battery-side connector and the device-side connector in a fit-together state.

FIG. 16 is a cross-sectional view of a fit-together state corresponding to the cross section taken along line B-B in FIG. 8.

FIG. 17 is a perspective view showing the connection structure for the battery module and the ECU of Embodiment 2 (before being fit together).

FIG. 18 is a perspective view showing the connection structure for the battery module and the ECU (fit-together state).

FIG. 19 is a perspective view showing the connection structure for the battery module and the ECU of Embodiment 3 (before being fit together).

FIG. 20 is a perspective view showing the connection structure for the battery module and the ECU (fit-together state).

### DESCRIPTION OF EMBODIMENTS Embodiment 1

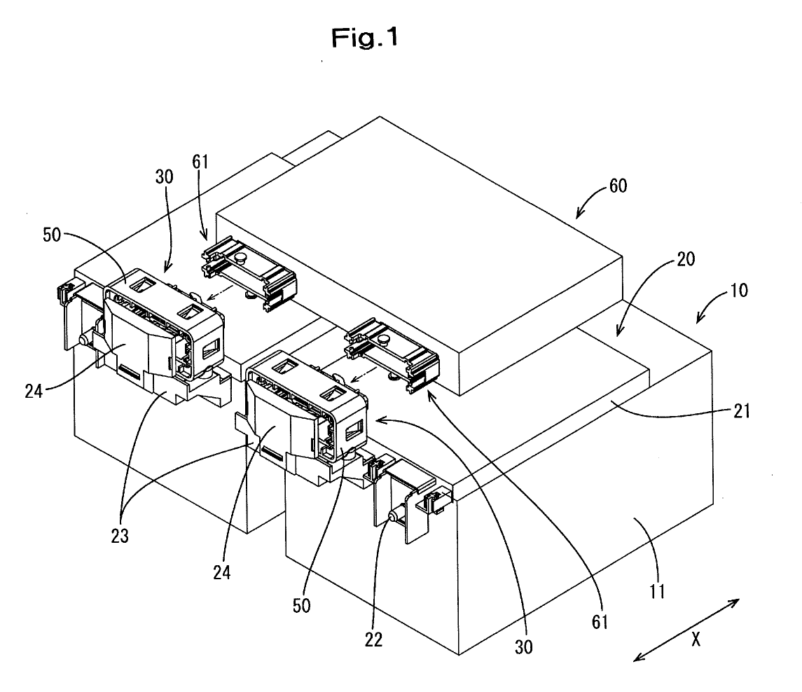

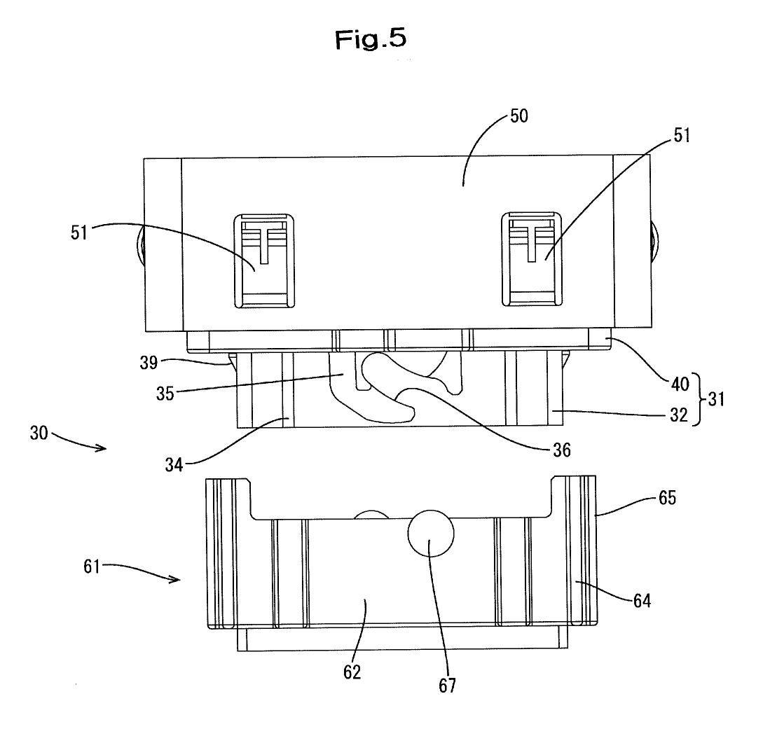

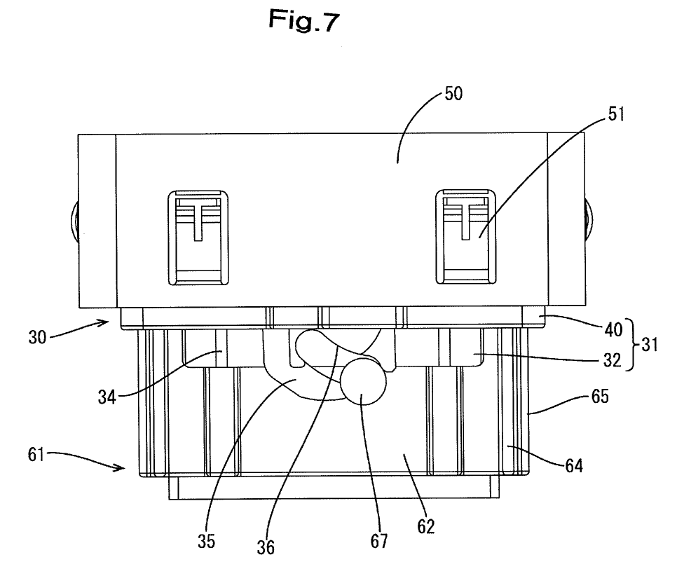

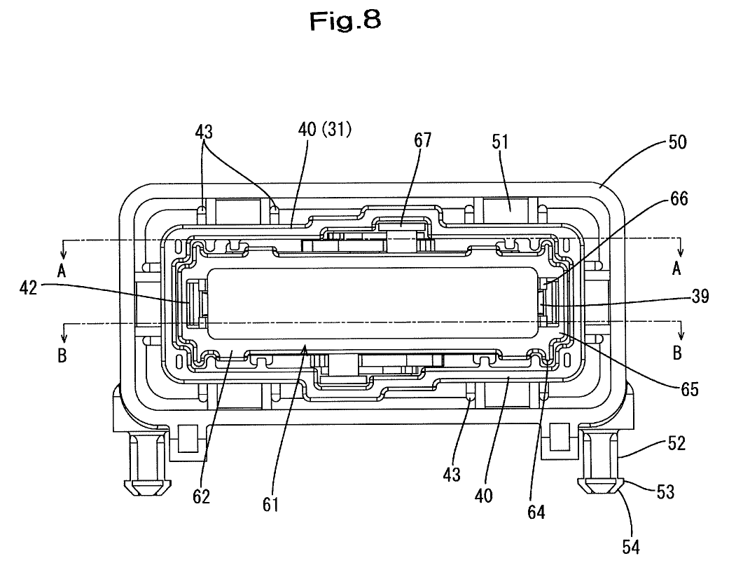

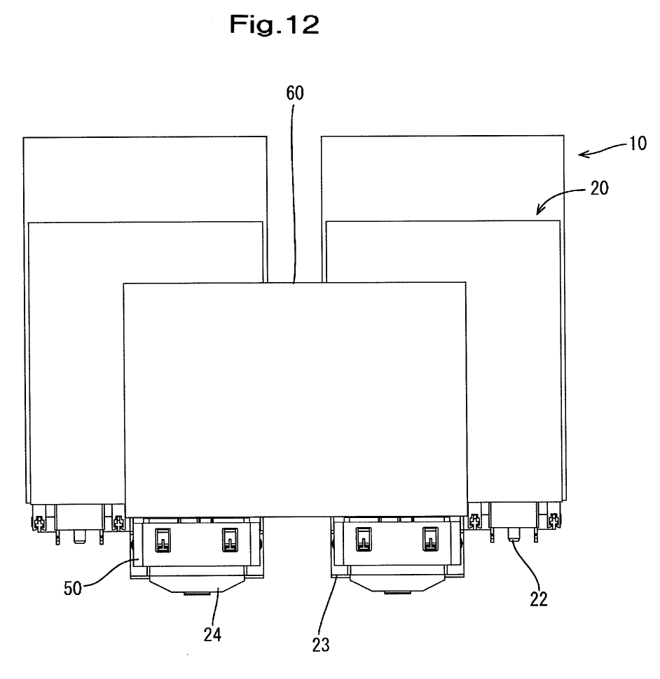

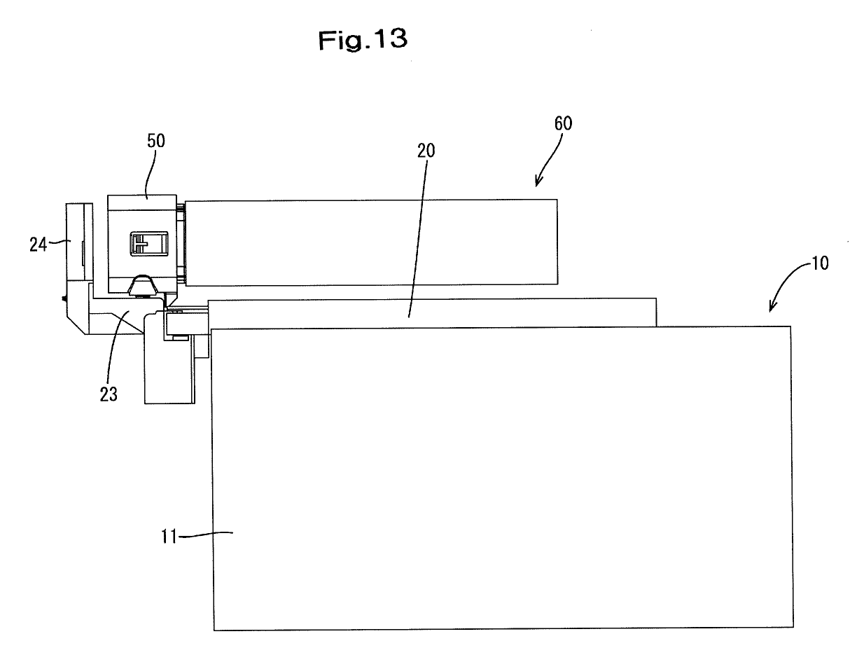

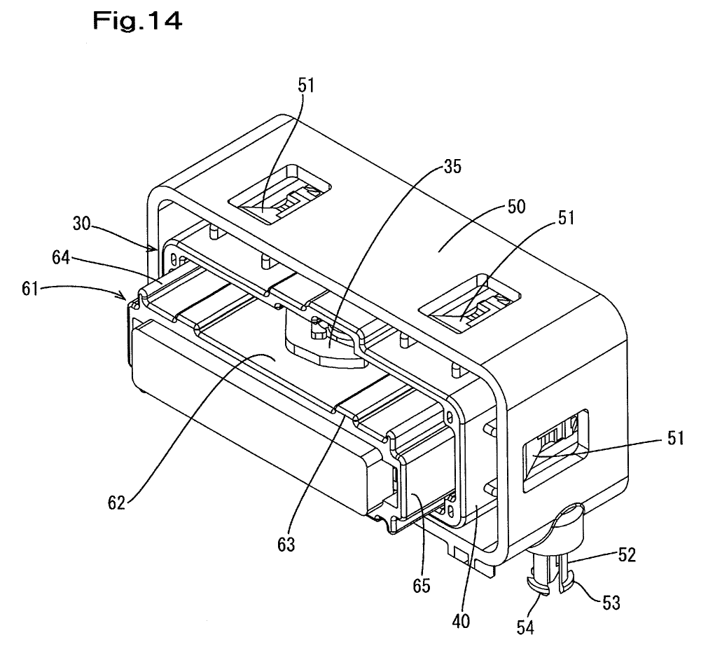

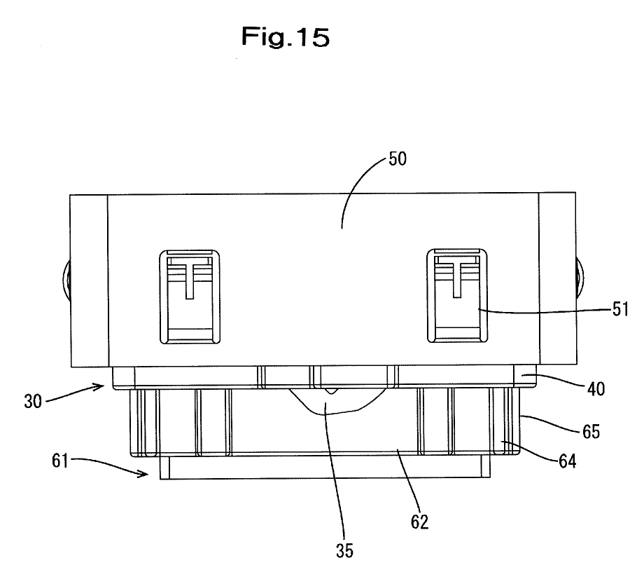

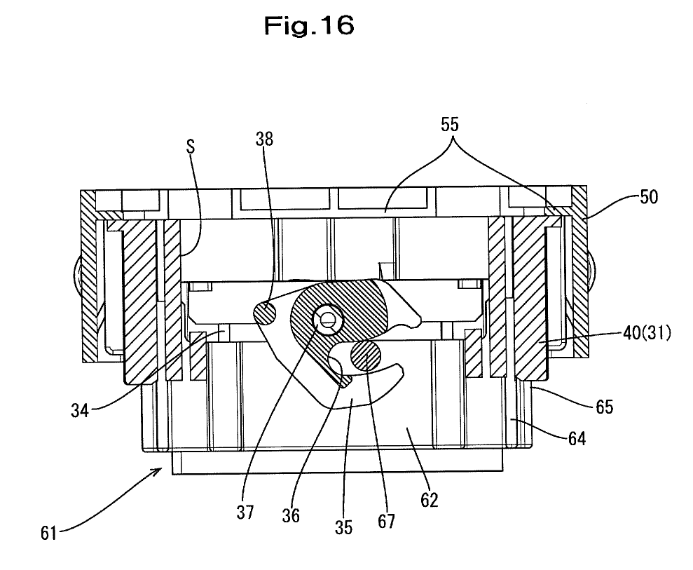

Embodiment 1 will be described with reference to FIGS. 1 to 16. Battery modules 10 (examples of power storage modules) of the present embodiment are used as a driving source for an electric automobile, a hybrid automobile, or the like, for example. Hereinafter, the up-down direction is described based on FIG. 1, and the front-rear direction is described with forward as the direction of fitting together with the partner-side connector and rearward as the opposite direction.

The battery modules 10 include single battery groups 11 (examples of power storage element groups) in which multiple single batteries (examples of power storage elements) are arranged in alignment. The upper surface of each single battery includes a pair of electrode terminals (not shown), and the electrode terminals of adjacent single batteries are electrically connected by a wiring module 20. The single battery groups 11 are connected to an ECU 60 (an example of a control device) via these wiring modules 20.

The wiring modules 20 include electrically conductive connection members that span between adjacent electrode terminals, detection wires that are connected to the electrode terminals and detect states of the single batteries, and resin protectors 21 that contain the connection members and detection wires. Note that the details of these constituent elements are omitted in the drawings, and the entireties of the wiring modules 20 are displayed as rectangular housing-shaped bodies.

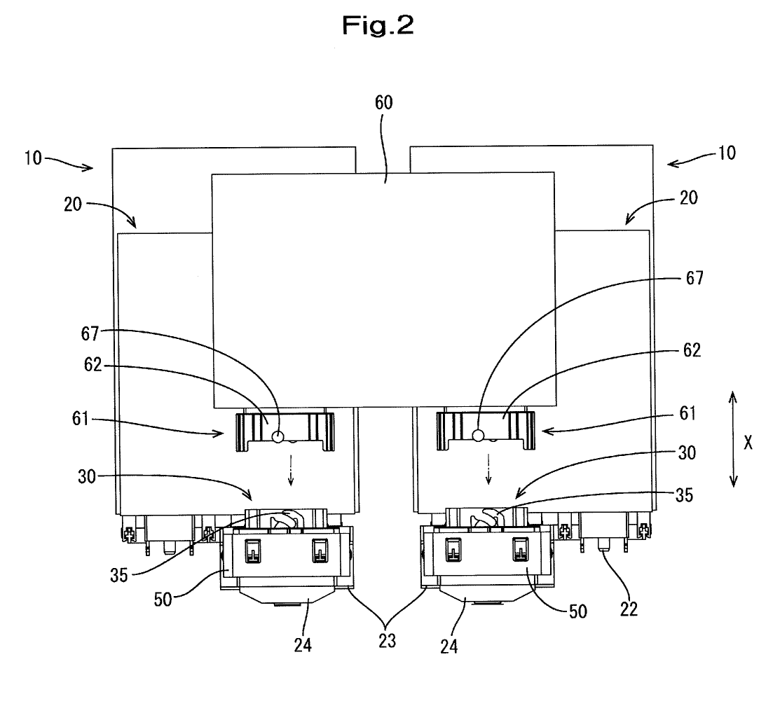

In the wiring modules 20, circular rod-shaped external connection terminals 22 for connecting to an external device are provided protruding on one end side in the alignment direction X (up-down direction in FIG. 2) of the single batteries. The external connection terminals 22 are provided near one end in the width direction (left-right direction in FIG. 2) of the wiring modules 20.

Also, in the wiring modules 20, battery-side connectors 30 are similarly integrally provided adjacent to the external connection terminals 22 on one end side in the alignment direction X of the single batteries.

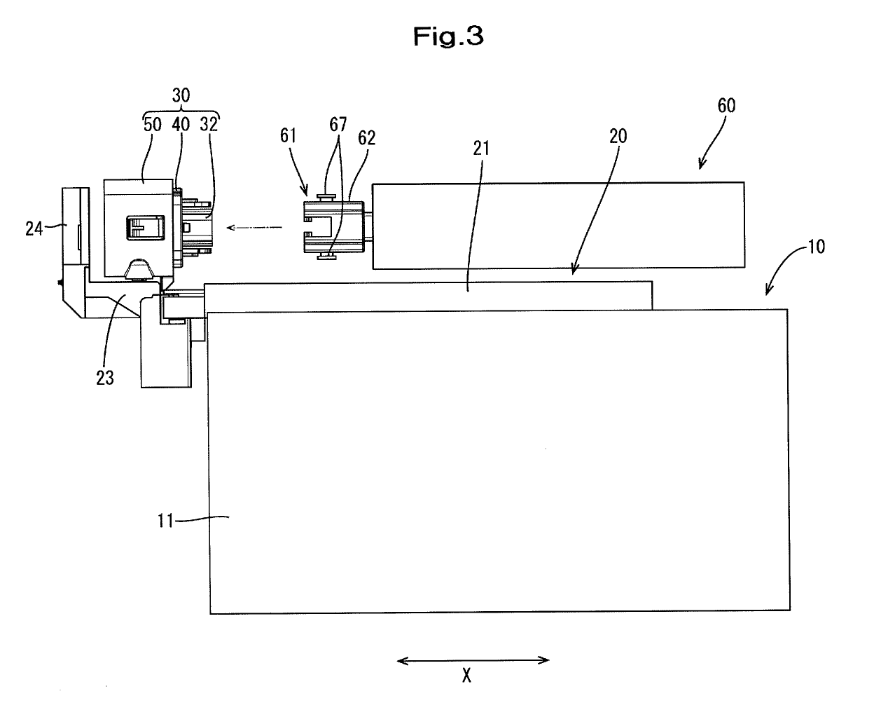

The battery-side connectors 30 are connectors for connecting the detection wires of the battery module 10 to the ECU 60 and are fixed to fixing platforms 23 that are integrally formed protruding laterally from the resin protectors 21 (see FIGS. 1 and 3).

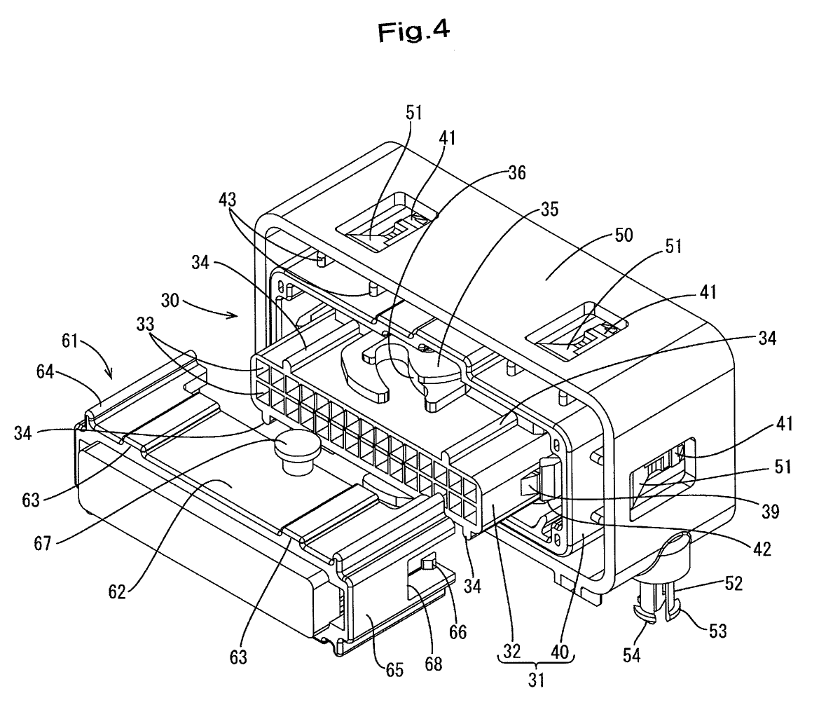

As shown in FIG. 4, the battery-side connector 30 includes: a battery-side housing 31 including a terminal containing portion 32 that has a laterally-extended flat block shape and a rectangular prism-shaped hood portion 40 that surrounds the terminal containing portion 32; and a holder 50 that surrounds the battery-side housing 31, and the battery-side connector 30 is integrally attached to the resin protector 21 (attachment platform 23).

Multiple cavities 33 that penetrate in the front-rear direction are formed in the terminal containing portion 32, and female terminals that are connected to the end portions of the detection wires are contained and held by being inserted into the cavities 33 from the rear.

Also, a pair of guiding ribs 34 that extend in the front-rear direction are provided near both end portions in the left-right direction on both the upper and lower outer surfaces of the terminal containing portion 32. These guiding ribs 34 are formed at different positions on the upper and lower surfaces, and when they are fit together with a later-described device-side connector 61, they perform restriction such that the device-side connector 61 is fit in a proper orientation.

Also, guiding protrusions 39 that stand upright while tilting from the forward side to the rearward side are provided at the central portion in the height direction of both left and right outer surfaces of the terminal containing portion 32.

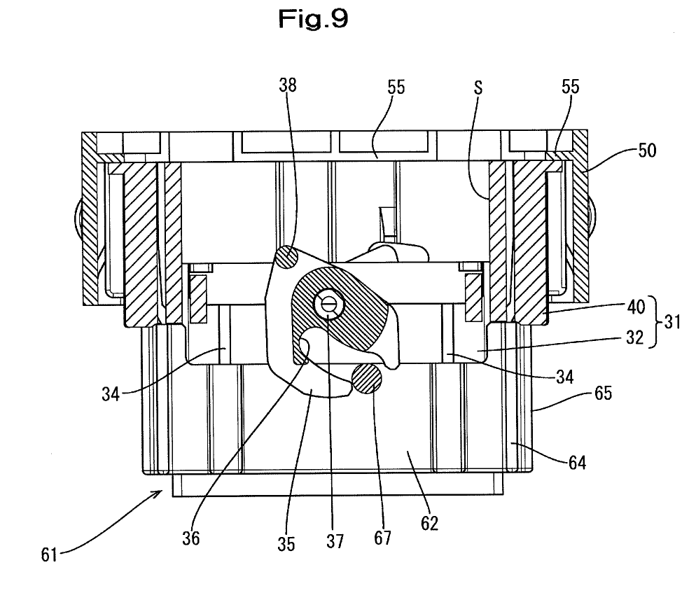

Furthermore, each of the upper and lower outer surfaces of the terminal containing portion 32 is provided with a lever 35 that is located between a pair of guiding ribs 34. These levers 35 are each provided with a cam groove 36 having a predetermined curved shape which opens toward one end, and the levers 35 are supported so as to be able to rotate centered about rotation shafts 37 provided on the terminal containing portion 32 in a vertically point-symmetrical orientation (see FIG. 9). Also, a coupling pin 38 is provided on the other end side, and the coupling pin 38 is coupled by being fit into a coupling groove provided on the hood portion 40. Also, before being fit together with the device-side connector 61, the entrances of the cam grooves 36 on both levers 35 are open to the front.

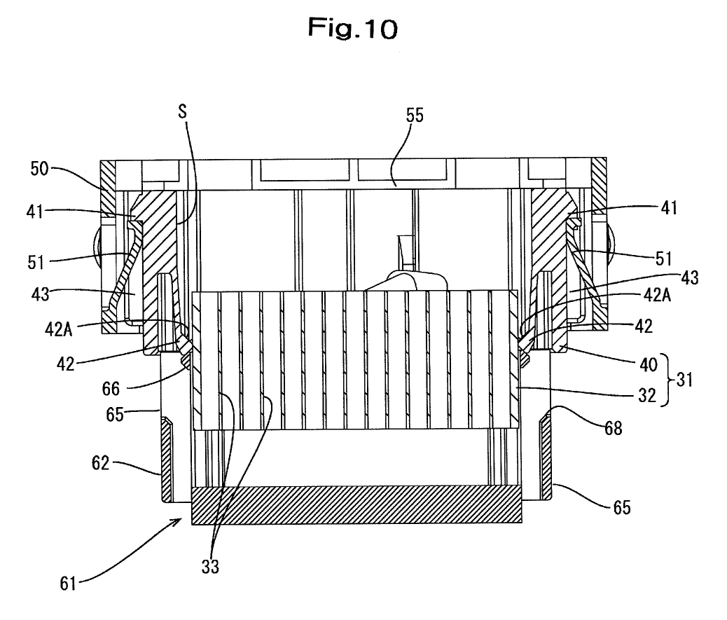

On the other hand, as described above, the hood portion 40 has a rectangular prism shape that surrounds the terminal containing portion 32, and near the rear end thereof, a total of 6 locking portions 41 (see FIG. 10) that protrude outward and lock the later-described holder 50 are provided, the upper and lower surfaces being provided with a pair of locking portions 41 each and the left and right surfaces being provided with one locking portion 41 each.

Also, a pair of lock arms 42 that extend frontward in the form of cantilevers are provided inside of the left and right side walls of the hood portion 40 (see FIG. 10). The leading end sides of the lock arms 42 can elastically deform outward, and when the device-side connector 61 is fit, locking hooks 42A provided on the leading end sides lock onto the locking protrusions 66 of the device-side housing 62, whereby both of the connectors 30 and 61 are held in a fit-together state. Note that the width dimension of the lock arms 42 is set to be greater than the width dimension of the guiding protrusions 39.

Furthermore, multiple restricting ribs 43 that extend in the front-rear direction are provided on the outer surface of the hood portion 40. These restricting ribs 43 are provided rearward from a position slightly rearward of the front end edge of the hood portion 40, and the entireties thereof are arranged in the later-described holder 50. These restricting ribs 43 are set to a height dimension at which a gap is included between the hood portion 40 and the inner wall of the holder 50. A total of 12 restricting ribs 43 are provided so as to be arranged on both sides of each locking portion 41, two pairs being provided on each of the top and bottom surfaces, and one pair being provided on each of the left and right side surfaces.

As shown in FIGS. 9 and 10, the above-described terminal containing portion 32 is arranged so as to leave a space S inward in the rear portion of the hood portion 40 and protrude forward from the front end of the hood portion 40. Detection wires lead out from the cavities 33 can be contained in this space S. Also, the leading end edges of the lock arms 42 are set to come into contact with the guiding protrusions 39 of the terminal containing portion 32 (see FIG. 4).

The battery-side housing 31 with the above-described configuration is held in the holder 50 and is integrally attached to the resin protector 21.

The holder 50 has a rectangular prism shape that extends in the front-rear direction and surrounds the hood portion 40 of the battery-side housing 31, and elastically-deformable locking pieces 51 that are cut in and raised rearward and inward are provided, a pair thereof being provided on each of the upper and lower wall portions and a pair thereof being provided on each of the left and right wall portions. These locking pieces 51 lock onto the locking portions 41 of the hood portion 40, whereby the battery-side housing 31 is held inside. Note that the rear end of the battery-side housing 31 (hood portion 40) is retained to the rear by a retaining portion 55 that is provided near the rear end of the holder 50 (see FIGS. 9 and 10).

The front side of the hood portion 40 is set to slightly protrude from the front end of the holder 50 when the battery-side housing 31 is held at the proper position in the holder 50.

Also, the holder 50 includes a pair of fixing legs 52 (examples of fixing portions) that extend downward from the lower surface of the holder 50, near both end portions in the left-right direction. The fixing legs 52 have a shape obtained by dividing a circular tube into three equal portions in the axial direction, can elastically deform inward in the radial direction, and flange portions 53 that project outward are provided on the lower edge thereof. The circumferential edge portions on the lower ends of the flange portions 53 are cut off obliquely toward the leading end side, and are made into guiding surfaces for when being inserted into fitting recesses (examples of fixed portions) of the later-described resin protector 21.

On the other hand, the device-side connector 61 includes a rectangular prism-shaped device-side housing 62 that can be inserted between the terminal containing portion 32 and the hood portion 40 of the battery-side housing 31. Both the upper and lower wall portions of the device-side housing 62 are provided with guiding grooves 63 that extend in the front-rear direction near both ends in the left-right direction, and in which the guiding ribs 34 of the above-described battery-side housing 31 can be received.

Also, support ribs 64 that extend in the front-rear direction are provided on the outer sides in the left-right direction of the guiding grooves 63. The support ribs 64 are fit along the inner sides of the corner portions of the hood portion 40 of the battery-side housing 31 and support the device-side housing 62 on the inner side of the hood portion 40.

Also, both the left and right wall portions of the device-side housing 62 are bulging portions 65 that bulge outward, and the frontward sides of the bulging portions 65 are cut-out portions 68 that are cut out into U shapes rearward from the edge portions of the bulging portions 65. A pair of locking protrusions 66 that protrude toward the surfaces that oppose each other are provided on the upper and lower end surfaces of the cut out portions 68.

When the device-side housing 62 is fit into the battery-side housing 31, the lock arms 42 advance into the cut-out portions 68 and the locking hooks 42A on the leading ends of the lock arms 42 go past and lock the locking protrusions 66, whereby the fit-together state of both housings 31 and 62 is held.

Note that the distance between the pair of locking protrusions 66 is set to a dimension that is slightly larger than the width dimension of the guiding protrusions 39 of the terminal containing portion 32, and the guiding protrusions 39 advance between the pair of locking protrusions 66, whereby the orientation in which the device-side housing 62 is inserted into the battery-side housing 31 is guided to the proper orientation.

Furthermore, cam pins 67 that can engage with the cam grooves 36 of the above-described levers 35 are provided in a standing manner on both the upper and lower outer surfaces of the device-side housing 62.

A pair of these device-side connectors 61 are provided on one side surface of an ECU having a flat box shape. That is, as shown in FIG. 1, two battery modules 10 are connected to one ECU 60.

On the other hand, as described above, the attachment platforms 23 that protrude toward the side (alignment direction X in which the single batteries are aligned, the left side in FIG. 3) are integrally provided on the resin protector 21. Fitting recesses into which the fixing legs 52 of the holder 50 are to be fit are provided on the upper surfaces of the attachment platforms 23. The battery-side connector 30 that holds the battery-side housing 31 in the holder 50 is integrally, or in other words, directly attached to the battery module 10 (resin protector 21) due to the fixing legs 52 of the holder 50 being fit into the fitting recesses of the attachment platforms 23.

The battery-side connector 30 is attached such that the direction of fitting together with the device-side connector 61 is a direction along the alignment direction X (left-right direction in FIG. 3) in which the single batteries are aligned, and such that the device-side connector 61 faces the direction of fitting from the battery module 10 side. Also, the rear surface side in the fitting direction of fitting together with the device-side connector 61 is covered by a rear surface cover 24 that is attached to the attachment platform 23.

The battery modules 10 and the ECU 60 of the present embodiment are connected as follows. First, as shown in FIGS. 1 to 3, two battery modules 10 are arranged in alignment apart from each other at a predetermined interval. In this state, the battery-side connectors 30 of the battery modules 10 are attached so as to protrude upward with respect to the upper surfaces of the wiring modules 20, and the fitting surfaces are made orthogonal to the upper surfaces of the wiring modules 20.

On the other hand, the ECU 60 is arranged opposing the wiring modules 20, and a pair of device-side connectors 61 that are provided on one side surface thereof (the surface on the left side in FIG. 3) are oriented in the direction opposing the battery-side connectors 30.

The ECU 60 and the battery-side connectors 30 are set to be fit together along the alignment direction X (left-right direction in FIG. 3) in which the single batteries are aligned.

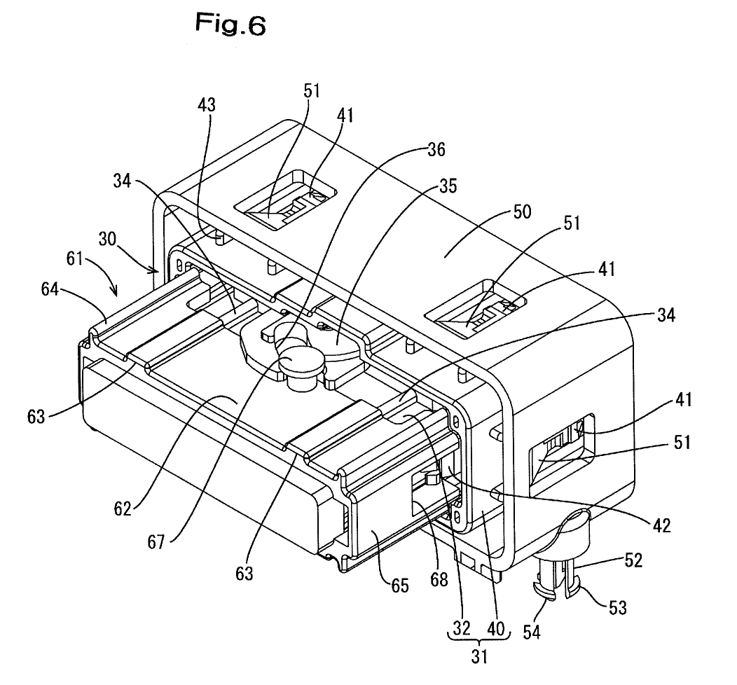

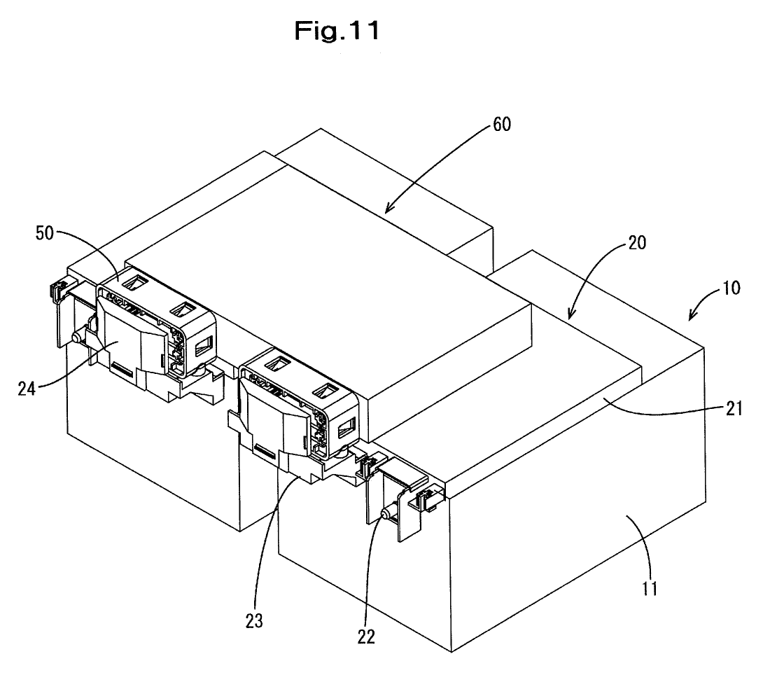

Specifically, when the ECU 60 is brought toward the battery-side connectors 30 and the device-side housings 62 are fit into the battery-side housings 31, first, as shown in FIGS. 6 to 10, the cam pins 67 of the device-side connectors 61 advance into the openings of the cam grooves 36 of the levers 35, which are in a predetermined orientation. Furthermore, when the ECU 60 (device-side connector 61) is pressed into the battery-side connectors 30, the levers 35 are rotated, the device-side connectors 61 are pulled toward the battery-side connectors 30 by a lever action between the cam grooves 36 and the cam pins 67, and both the connectors 30 and 61 are fit together properly (see FIGS. 11 to 16).

Note that at this time, the guiding ribs 34 provided on the terminal containing portions 32 are guided into the guiding grooves 63 of the device-side housings 62, and thus, the terminal containing portions 32 and the device-side housings 62 are fit together in the proper orientation. Also, the support ribs 64 that are provided on the device-side housings 62 fit into the corner portions of the hood portions 40 of the battery-side housings 31, and the device-side housings 62 are supported by the hood portions 40.

Furthermore, the lock arms 42 provided on the hood portions 40 lock onto the engaging protrusions 66 of the device-side housings 62, whereby the fit-together state of the battery-side housings 31 and the device-side housings 62 is held. Note that at this time, the guiding protrusions 39 of the terminal containing portions 32 advance between the pairs of locking protrusions 66 while the lock arms 42 are elastically deformed, and therefore, in this manner as well, the fit-together orientation of the battery-side housings 31 and the device-side housings 62 can be guided to the proper orientation.

According to this kind of connection structure for the battery modules 10 and the ECU 60 of the present embodiment, the battery modules 10 and the ECU 60 are connected by fitting together the battery-side connectors 30 and the device-side connectors 61, which are each provided integrally, and therefore the detection wires are not pulled out of the battery modules 10 and exposed to the outside, thus eliminating the need for routing space for the detection wires outside of the battery modules 10.

Also, even if there are a large number of detection wires and a large number of terminals in the connectors, the battery-side connectors 30 and the device-side connectors 61 are configured to fit together using a cam mechanism, and therefore the fitting-together task can be performed easily.

Also, the battery-side connectors 30 are configured such that the fixing legs 52 provided on the holders 50 are fixed to the fitting recesses of the attachment platforms 23 provided on the resin protectors 21, and therefore it is sufficient to integrate the battery-side connectors 30 and the resin protectors 21 after they are manufactured separately. That is, the manufacturing cost can be suppressed lower compared to the case of manufacturing everything integrally.

Also, the battery-side housings 31 are configured to be held in the holders 50 such that the tolerances can be absorbed, and therefore even if a manufacturing tolerance and an attachment tolerance are generated, these tolerances can be absorbed.

Furthermore, the ECU 60 is arranged opposing the wiring modules 20, and the fitting-together direction of the battery-side connectors 30 and the device-side connectors 61 is set along the alignment direction X in which the single batteries are aligned, and therefore the entirety can be put together compactly.

### Embodiment 2

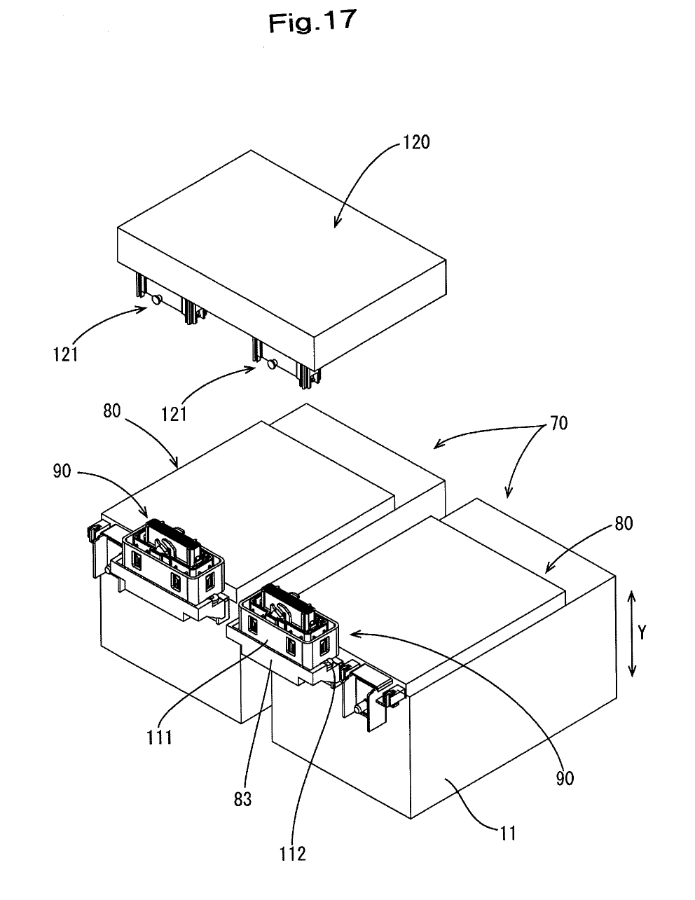

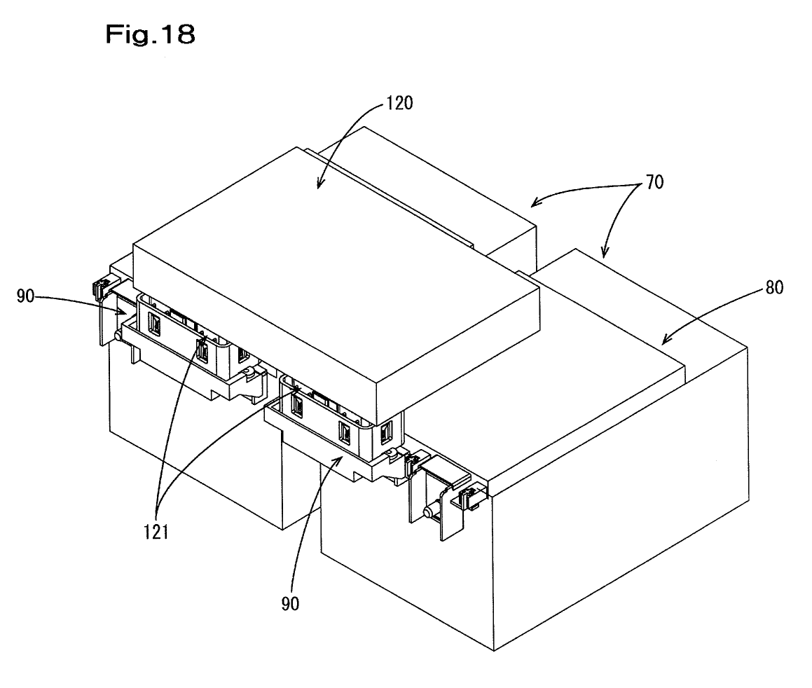

Next, Embodiment 2 will be described with reference to FIGS. 17 and 18. Note that only configurations that are different from those of Embodiment 1 will be described hereinafter, reference signs obtained by adding 60 will be used for configurations similar to those of Embodiment 1, and redundant description will not be given.

The connection structure of the battery modules 70 and the ECU 120 of the present embodiment differs from that of the above-described embodiment in the fitting-together direction of the battery-side connectors 90 and the device-side connectors 121.

The battery-side connectors 90 and the device-side connectors 121 of the present embodiment are fit together in a direction Y that intersects the attachment surfaces of the single battery group 11 to which the wiring modules 80 are attached, or more specifically, in the up-down direction of FIG. 17. The battery-side connectors 90 have a similar configuration to those in Embodiment 1, except for the installation positions of the fixing legs 112 on the holders 110. The fixing legs 112 are provided so as to extend in the direction along the rectangular prism-shaped wall portion of the holders 110. Accordingly, the battery-side connectors 90 orient the fitting-together surfaces upward when attached to the attachment platforms 83 of the wiring modules 80.

On the other hand, the device-side connectors 121 provided in the ECU 120 are provided on the lower surface side of the ECU 120 such that the fitting surfaces thereof face toward the wiring modules 80.

With these battery modules 70 and ECU 120 of the present embodiment, the ECU 120 is arranged opposing the wiring modules 80, and the direction of fitting together the battery-side connectors 90 and the device-side connectors 121 is set to a direction Y that intersects the attachment surfaces of the single battery group 11 on which the wiring modules 80 are attached, and therefore with this kind of configuration as well, the entirety can be put together compactly.

### Embodiment 3

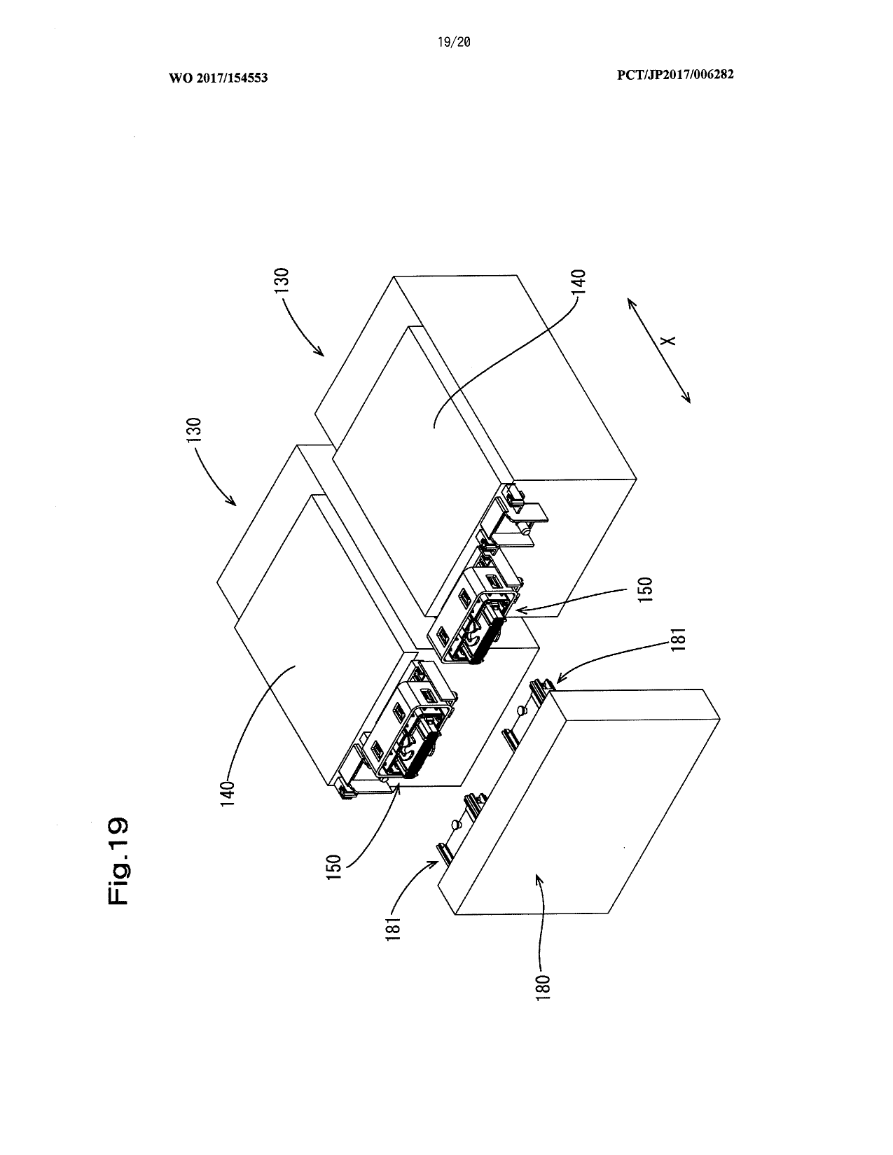

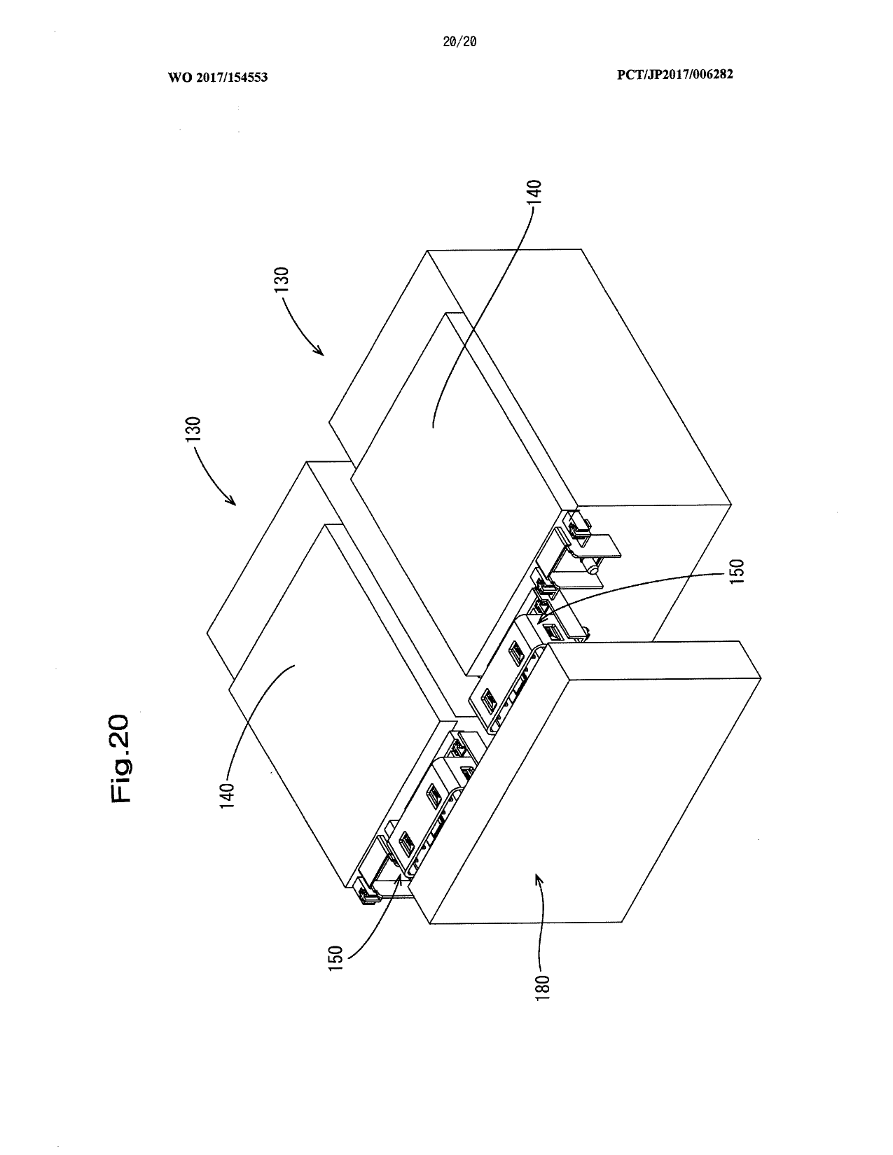

Next, Embodiment 3 will be described with reference to FIGS. 19 and 20. Note that only configurations that differ from those of Embodiment 1 will be described below, reference signs obtained by adding 120 will be used for configurations that are similar to those of Embodiment 1, and redundant description will not be given.

In the present embodiment, the ECU 180 differs from the above-described embodiments in that it is arranged aligned in the alignment direction X in which the single batteries are aligned. Also, the device-side connectors 181 of the ECU 180 are provided with their fitting surfaces facing the side surfaces of the battery modules 130.

On the other hand, the battery-side connectors 150 are provided integrally with the wiring modules 140 such that the fitting surfaces of the battery-side connectors 150 face the side opposite to that in Embodiment 1, that is, the lateral side.

With these battery modules 130 and ECU 180 of the present embodiment, the ECU 180 is arranged aligned in the alignment direction X in which the single batteries are aligned, and the fitting direction of the battery-side connectors 150 and the device-side connectors 181 is set along the alignment direction X, and therefore, with this kind of configuration as well, the entirety can be put together compactly.

### Other Embodiments

The technique disclosed in the present specification is not limited to the embodiments described with reference to the above description and the drawings, and for example, the following embodiments are also encompassed in the technical scope.

(1) In the above-described embodiments, the battery-side connectors and the device-side connectors are fit together and separated through a cam action between levers and cam pins, but the levers and cam pins can also be omitted.

(2) In the above-described embodiments, the battery-side connector is integrally attached to the resin protector, but for example, another member such as a fixing frame for fixing the battery-side connector, for example, may also be provided.

(3) In the above-described embodiments, the battery-side connector is attached to the battery-side module (resin protector) using a holder, but it is also possible to use a configuration in which the holder is not provided and a fixing portion is provided directly on the battery-side housing.

(4) Alternatively, it is also possible to use a configuration in which the battery-side connector is formed integrally with the resin protector in advance, for example.

(5) A member that is different from a single battery (power storage element) may be included in the single battery group (.power storage element).

(6) The configuration of the battery-side connector and the device-side connector is not limited to the above-described embodiments.

(7) In the above-described embodiments, the two battery modules are attached to the one ECU, but the number of connections of the ECU and the battery module is not limited to the above-described embodiments.

### LIST OF REFERENCE NUMERALS

10, 70, 130 Battery module (power storage module)

11 Single battery group (power storage element)

20, 80, 140 Wiring module

21 Resin protector

23, 83 Attachment platform (fixed portion)

30, 90, 150 Battery-side connector (module-side connector)

31 Battery-side housing (module-side housing)

35 Lever

36 Cam groove

37 Rotation shaft

50 Holder

52 Fixing leg (fixing portion)

60, 120, 180 ECU (control device)

61, 121, 181 Connector-side housing

67 Cam pin

X Alignment direction

Y Intersecting direction

1. A connection structure for a power storage module and a control device, the power storage module including a wiring module attached to a power storage group including a plurality of power storage elements, and the control device is configured to detect states of the power storage elements,
wherein the power storage module includes detection wires configured to detect the states of the power storage elements and to be connected to the control device,
the connection structure including a module-side connector connected to the detection wires and provided integrally on the power storage module, and a device-side connector that is provided integrally on the control device, the module-side connector and the device-side connector being fit together.

2. The connection structure for the power storage module and the control device according to claim 1, wherein
the module-side connector includes a module-side housing that contains terminals connected to terminal ends of the detection wires, and a lever having a cam groove is provided on the module-side housing so as to be rotatable about a support shaft,
the device-side connector includes a device-side housing that can fit into the module-side housing, and a cam pin that engages with the cam groove is provided on the device-side housing at a position opposing the lever, and
the module-side connector and the device-side connector are fit together and separated through a cam action accompanying engagement of the cam groove and the cam pin through rotation of the lever.

3. The connection structure for the power storage module and the control device according to claim 1, wherein
the wiring module includes a resin protector that holds the detection wires, and
a fixing portion provided on the module-side connector is fixed to a fixed portion provided on the resin protector.

4. The connection structure for the power storage module and the control device according to claim 3, wherein
the module-side connector includes a module-side housing that contains terminals connected to terminal ends of the detection wires, and a lever having a cam groove is provided on the module-side housing so as to be rotatable about a support shaft,
the device-side connector includes a device-side housing that can fit together with the module-side housing, and a cam pin that engages with the cam groove is provided on the device-side housing at a position opposing the lever,
the module-side connector and the device-side connector are fit together and separated through a cam action accompanying engagement of the cam groove and the cam pin through rotation of the lever,
the module-side connector includes a holder and the module-side housing is held such that a tolerance can be absorbed in the holder, and
the fixing portion is provided in the holder.

5. The connection structure for the power storage module and the control device according to claim 1, wherein
the control device is arranged opposing the wiring module, and
the direction in which the module-side connector and the device-side connector are fit together is an alignment direction in which the power storage elements are aligned.

6. The connection structure for the power storage module and the control device according to claim 1, wherein
the control device is arranged opposing the wiring module, and
the direction in which the module-side connector and the device-side connector are fit together is a direction intersecting an attachment surface of the power storage elements on which the wiring module is attached.

7. The connection structure for the power storage module and the control device according to claim 1, wherein
the control device is arranged aligned in an alignment direction in which the power storage elements are aligned, and
the direction in which the module-side connector and the device-side connector are fit together is the alignment direction.
